(19) United States
(12) Patent Application Publication
(10) Pub. No.: US 2024/0375759 A1
(43) Pub. Date: Nov. 14, 2024

(54) MARINE VESSEL FOR GENERATING ELECTRICITY FOR ONSHORE DISTRIBUTION

(71) Applicants: Crowley Government Services, Inc., Jacksonville, FL (US); BWXT ADVANCED TECHNOLOGIES LLC, Lynchburg, VA (US)

(72) Inventors: Jeffrey D. Brunell, Saint Johns, FL (US); Joshua L. Parker, Forest, VA (US); Jonathan E. Stephens, Forest, VA (US); Justin P. Monito, Lynchburg, VA (US); Erik T. Nygaard, Lynchburg, VA (US); Jonathan G. Parrott, Vashon, WA (US); Joshua D. Temple, Bellevue, WA (US)

(21) Appl. No.: 18/654,955

(22) Filed: May 3, 2024

Related U.S. Application Data
(60) Provisional application No. 63/464,861, filed on May 8, 2023.

(51) Int. Cl. B63H 21/20; B63H 1/14

(52) U.S. Cl. CPC B63H 21/20; B63H 1/14; B63H 2021/205; B63H 2021/207

(57) ABSTRACT

A marine vessel and a method of operating the marine vessel. The marine vessel includes an electricity generation system having a nuclear reactor and an electrical generator. The nuclear reactor is coupled to the electrical generator to generate electricity. The marine vessel may also include a propulsion system having an engine and a propulsor that receives torque from the engine to move the hull through a body of water surrounding the hull. The marine vessel may be part of a temporary power system having an electrical cable electrically connecting the electrical generator to an onshore electrical distribution system. A plurality of buoys may support the electrical cable between the marine vessel and the onshore electrical distribution system. The method of operating the marine vessel may include starting up the nuclear reactor and maintaining the nuclear reactor in a standby condition, while the marine vessel is underway.

### CROSS-REFERENCE TO RELATED APPLICATION

This application claims the benefit under 35 U.S.C. § 119 (e) of U.S. Provisional Patent Application No. 63/464,861, filed May 8, 2023, and titled “MARINE VESSEL FOR GENERATING ELECTRICITY FOR ONSHORE DISTRIBUTION,” the entirety of which is incorporated herein by reference.

### FIELD OF THE INVENTION

The invention relates to a marine vessel, and an electricity generation and distribution system including the marine vessel.

### BACKGROUND OF THE INVENTION

Natural disasters and severe weather, such as hurricanes, earthquakes, thunderstorms, and winter storms, can cause power outages. During such events, power plants producing electricity may be damaged such that they are offline, or communities may be otherwise disconnected from the power plants, interrupting the distribution of electricity. Military conflict can also result in damage to power plants or other disconnection from the power plant, resulting in similar disruptions of electricity. In addition, attacking or defending military forces may not have access to such power plants depending upon the territory those forces control.

### SUMMARY OF THE INVENTION

In one aspect, the invention relates to a marine vessel comprising a hull, a propulsion system, and an electricity generation system. The propulsion system includes an engine and a propulsor. The engine produces torque when in operation and is drivingly coupled to the propulsor to transmit torque from the engine to the propulsor. The propulsor receives torque from the engine to move the hull through a body of water surrounding the hull. The electricity generation system includes a nuclear reactor and an electrical generator. The nuclear reactor is coupled to the electrical generator to generate electricity to be capable of providing electricity to shore when the nuclear reactor is operating at power.

In another aspect, the invention relates to a temporary power system including a marine vessel and an onshore electrical distribution system having an onshore electrical connection. The marine vessel includes a hull and an electricity generation system. The electricity generation system includes an electrical generator and a nuclear reactor. The electrical generator is coupled to the nuclear reactor to generate electricity when the nuclear reactor is operating. An electrical cable electrically connects the electrical generator and the onshore electrical connection to provide electricity from the electricity generation system to the onshore electrical distribution system. The temporary power system also includes a support for supporting the electrical cable between the marine vessel and the onshore electrical connection.

In a further aspect, the invention relates to a method of operating a marine vessel having an electricity generation system. The electricity generation system includes a nuclear reactor and an electrical generator. The method includes operating the marine vessel underway, starting up the nuclear reactor, while the marine vessel is underway, and maintaining the nuclear reactor in a standby condition, while the marine vessel is underway.

These and other aspects of the invention will become apparent from the following disclosure.

### BRIEF DESCRIPTION OF THE DRAWINGS

FIG. 1 shows a marine vessel equipped with a nuclear reactor in accordance with a preferred embodiment.

FIG. 2 is a side, cut-away view of the marine vessel shown in FIG. 1.

FIG. 3 is a schematic view of the marine vessel shown in FIG. 1 as part of a temporary power system.

FIG. 4 shows a view of another marine vessel equipped with a nuclear reactor.

FIG. 5 is a side view of the marine vessel shown in FIG. 4.

### DETAILED DESCRIPTION OF THE PREFERRED EMBODIMENTS

As discussed above, natural disasters and severe weather can cause power outages by shutting down power plants and otherwise interrupting the distribution of electricity. Such power outages can be particularly acute where a community is isolated or remote. For example, many U.S. territories, such as Guam and Puerto Rico, are isolated from power plants outside of the territory because they are islands. Other remote communities, such as in Alaska, for example, have limited or no interconnection with other power generating plants. Because of the lack or limited interconnection, power outages at these power plants may cause a severe and long-lasting power outage.

So-called “microreactors” are nuclear reactors that generate a relatively small amount of electricity. For example, these microreactors may have a power output that is 50 megawatts (MW) or less, such as between 5 MW and 50 MW. Because of their relatively small size, microreactors can be designed to be portable to these remote and isolated locations to provide a temporary power source when the remote or isolated community is experiencing a power outage, such as from natural disasters and severe weather or, as discussed further below, where secure, safe, and reliable electricity is needed for defense applications. In embodiments discussed herein, a marine vessel, such as a ship or an articulated barge, is equipped with at least one microreactor. The microreactor on the marine vessel may be used as a temporary power plant to provide electricity onshore in the event of a power outage or when other temporary electricity power production is needed. The marine vessel is thus preferably positioned close to shore and then connected to an onshore electrical distribution system, such as a grid or a microgrid, to provide electricity on shore.

The marine vessel discussed herein may also be used for military purposes. As discussed above, electricity may not be available or may be undependable during times of conflict. The marine vessel discussed herein may be used to provide electricity for military forces where maritime access is available. Expeditionary forces are forces deployed away from established military facilities and require self-sustaining logistical capabilities including electricity production. Such forces, particularly those engaged in amphibious operations, may not have access to existing electricity production facilities. For example, forces establishing a beachhead may not have access to electricity produced on shore. The marine vessel discussed herein can be rapidly deployed, as discussed below, to provide electricity and support expeditionary operations.

As used herein, directional terms forward (fore), aft, inboard, and outboard have their commonly understood meaning in the art. Relative to the ship, forward is a direction toward the bow, and aft is a direction toward the stern. Likewise, inboard is a direction toward the center of the ship, and outboard is a direction away from the center of the ship.

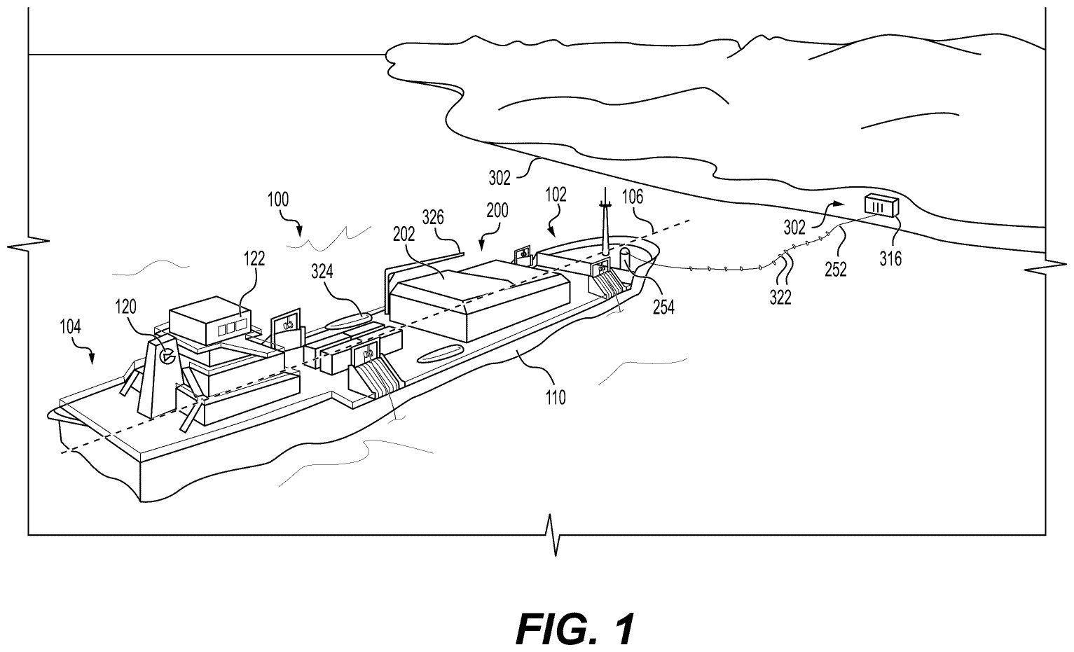

FIG. 1 shows a marine vessel equipped with a nuclear reactor in accordance with a preferred embodiment. The marine vessel shown in FIG. 1 is a ship 100 having a hull 110 and a superstructure 120. The ship 100 has a bow 102, a stern 104, and a longitudinal centerline 106. The longitudinal centerline 106 extends from the bow 102 to the stern 104 down the middle of the ship 100, halfway between a port side of the hull 110 and a starboard side of the hull 110. The ship 100 may preferably be a tanker-style ship or even a converted tanker ship having a main deck 112. The superstructure 120 may include a pilothouse 122 (i.e., a bridge) for operating the ship 100 and accommodations for the crew. The superstructure 120 may be located in the aft half, and, more preferably, in the aft third of the ship 100 and extends upward to position the pilothouse 122 above the main deck 112 to provide visibility over the bow 102. The hull 110 of this embodiment is a displacement hull.

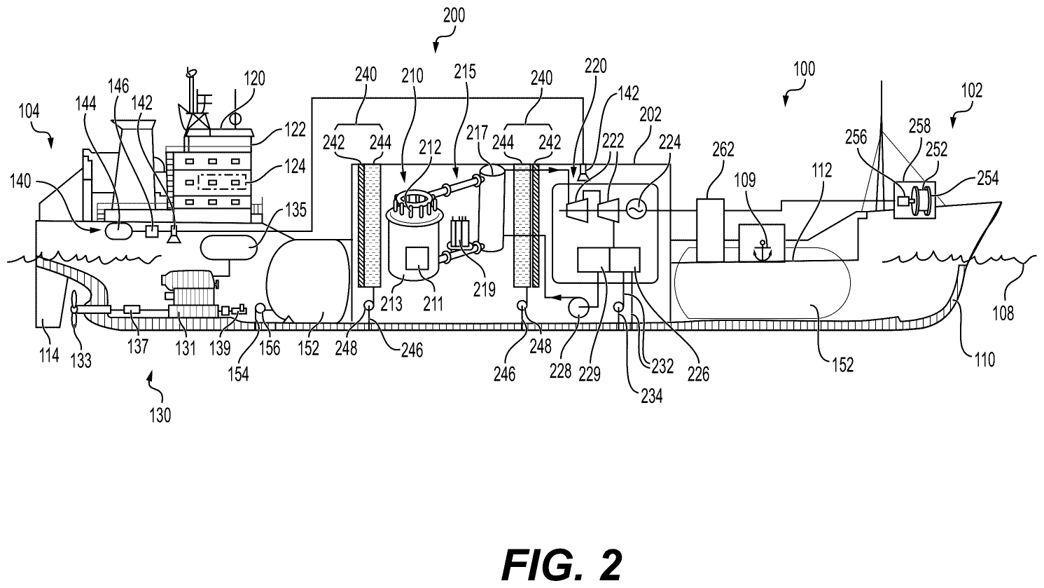

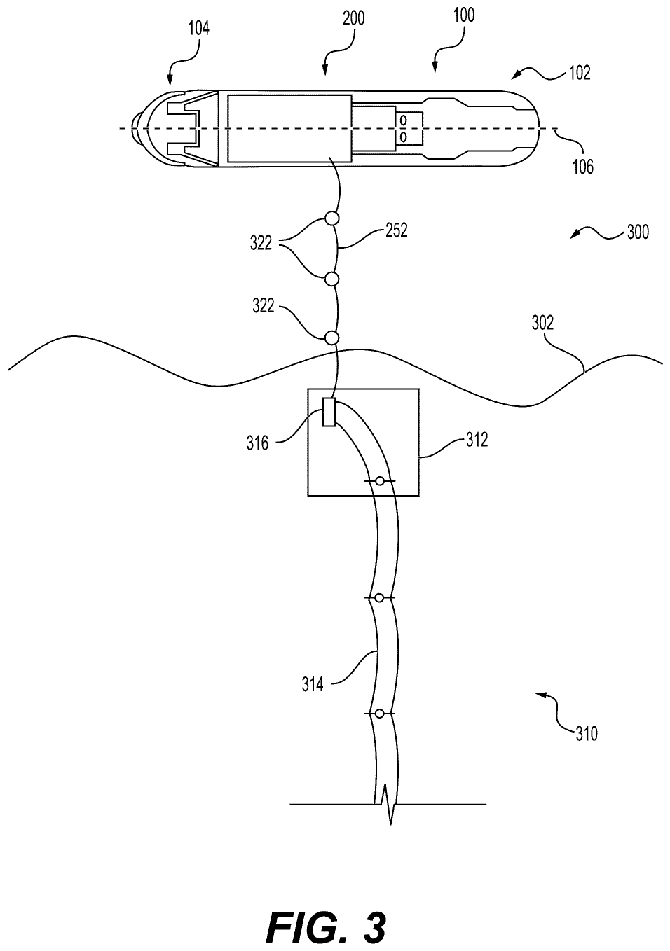

As noted above, the ship 100 is preferably positioned close to shore 302 to be connected to an onshore electrical distribution system 310 (see also FIG. 3). The water close to shore for the various islands and other remote locations may be relatively shallow. In addition, the ship 100 may be used to provide electricity to remote locations that are accessible by a navigable river, and such navigable rivers and anchorages on these rivers may also be relatively shallow. Accordingly, the ship 100 and, more specifically, the hull 110, may preferably be designed to be a shallow draft vessel. The hull 110 preferably may have a minimum mean draft of 12 feet or less. To achieve such a draft, the ship 100 and, more specifically, the hull 110 has a relatively large beam width. The molded beam width may be, for example, at least 80 feet, such as from 80 feet to 90 feet. In this embodiment, the ship 100 and, more specifically, the hull 110 has an overall length that is at least 360 feet, such as from 360 feet to 400 feet, and a depth (from the keel to the main deck 112) of at least 20 feet. The hull dimensions, however, may vary, and other principal dimensions of the hull 110 may be used provided the ship 100 can carry the weight of the electricity generation system 200 (including nuclear reactor 210, FIG. 2), discussed further below, and other typical cargo/deadweight with the desired draft.

FIG. 2 is a side, cut-away view of the ship 100 shown in FIG. 1. The ship 100 is equipped with an electricity generation system 200. The electricity generation system 200 is a nuclear power plant that includes a nuclear reactor 210 to generate heat and, subsequently, a hot gaseous fluid, such as steam, that rotates turbines 222 drivingly connected to an electrical generator 224 to generate electricity as the turbines 222 rotate. The use of a steam cycle described below is one example of several energy conversion options that may be used with the nuclear reactor 210 as part of the electricity generation system 200. Other suitable energy conversion options include, for example, a primary-only Brayton cycle, a primary coolant loop utilizing an intermediate heat exchanger to secondary Brayton cycle, or a combined cycle, such as gas turbine in the primary coolant loop and Rankine/steam cycle in the secondary coolant loop.

In this embodiment, the nuclear reactor 210 is a high-temperature gas reactor (HTGR), but any suitable nuclear reactor 210 and power plant design may be used, such as a pressurized water reactor (PWR) or a boiling water reactor (BWR), for example. One such suitable nuclear reactor 210 is described in U.S. Patent Application Pub. No. 2020/0373027, the disclosure of which is incorporated by reference herein in its entirety. Also, in this embodiment, the nuclear reactor 210 is a microreactor. In the embodiment shown in FIG. 2, the electricity generation system 200 is shown with a single nuclear reactor 210 but electricity generation system 200 may be equipped with two or more nuclear reactors 210. In such an embodiment, as standardized nuclear reactor design (e.g., a standardized microreactor design), increasing the total electrical output of the electricity generation system 200 without requiring a new reactor design and the associated licensing and other regulatory compliance processes.

The nuclear reactor 210 includes a core 211 contained within a reactor vessel 213 (also referred to as a pressure vessel). The core 211 contains nuclear fuel and through which a fluid flows. The fluid flowing through the core 211 is referred to herein as a coolant (primary coolant, in this embodiment) as the fluid absorbs heat from the nuclear reactions occurring in the nuclear fuel within the core 211. As noted above, the nuclear reactor 210 of this embodiment is a high-temperature gas reactor and the primary coolant is a gas. Suitable gases that may be used as the primary coolant include, for example, carbon dioxide or helium. Any suitable nuclear fuel may be used, including, for example, uranium. The uranium may be in any suitable form. One such suitable form is a tristructural-isotropic (TRISO) fuel particle. The particle may consist of a kernel of uranium in a ceramic form, such as uranium oxide, which has been coated by a plurality of layers. In some embodiments of a TRISO fuel particle, the kernel of uranium is coated with four layers of three isotropic materials. With the primary coolant being a gas, the core 211 also includes a moderator. Graphite is an example of a suitable moderator, and, in some embodiments, the TRISO fuel particle is arranged in a prismatic configuration within a prismatic graphite block arranged in the core to have the primary coolant flow therethrough. However, other suitable fuel arrangements may be used, such a pebble bed reactor design. Control rods containing neutron poisons may be used within the reactor to control the nuclear reactions within the core 211. The control rods may be operated by a control rod drive mechanism (CRDM) 212. Suitable control rod drive mechanisms are known in the art and may include an electric motor driving a screw or nut to move the control rod into the core 211 and reduce the reactivity or further out of the core 211 to increase reactivity.

The nuclear reactor 210 of this embodiment includes a plurality of fluid loops for a fluid (also referred to as a coolant herein) to flow through. In this embodiment, the nuclear reactor 210 includes a primary coolant loop 215 through which the primary coolant flows. As discussed above, the primary fluid flows through the core 211 and is heated by the nuclear reactions within the core 211 when the reactor is critical. In the primary coolant loop 215, the core 211 and reactor vessel 213 are fluidly coupled to a heat exchanger, which, in this embodiment, is a steam generator 217. The heated primary coolant flows from the core 211 to the steam generator 217, and as the primary coolant flows through the steam generator 217, heat from the primary coolant is transferred to (absorbed by) a secondary coolant that is also flowing through the steam generator 217. After the primary coolant has been cooled, the primary coolant flows through the primary coolant loop 215 from the steam generator 217 back to the reactor vessel 213 and core 211. A suitable gas circulator 219 may be located in the primary coolant loop 215, such as downstream of the steam generator 217 and upstream of the reactor vessel 213 to help circulate and to cause the primary coolant to flow within the primary coolant loop 215.

The secondary coolant may be any suitable coolant to absorb heat from the primary coolant. Preferably, the secondary coolant is a two-phase coolant, such as water in this embodiment. In this embodiment, as the secondary coolant absorbs the heat from the primary coolant in the steam generator 217, the water (secondary coolant) changes phase to steam (water vapor). The secondary coolant is located within a secondary coolant loop 220 and the steam generator 217 is fluidly coupled to at least one turbine 222. In this embodiment, a plurality of turbines 222 connected in series are used. As the steam (secondary coolant) flows through the turbines 222, the steam rotates the turbines 222. The turbines 222 are drivingly connected to an electrical generator 224 such that, as the turbines 222 rotate, the electrical generator 224 generates electricity.

One or more condensers 226 are positioned within the secondary coolant loop 220 downstream of the turbines 222 and upstream of the steam generator 217. The steam (secondary coolant) flows from the turbines 222 to the condensers 226, and is condensed from steam back to liquid. The condensers 226 are fluidly connected to the steam generator 217 and the condensed secondary coolant (liquid) flows back to the steam generator 217. More generally, the condenser 226 may be referred to has a heat exchanger configured cool and/or condense the secondary coolant by removing heat. In systems where the coolant (e.g., secondary coolant) is a gas such components may also be referred to as coolers. A secondary coolant pump 228 may located within the secondary coolant loop 220 downstream of the condensers 226 and upstream of the steam generator 217 to circulate the secondary coolant within the secondary coolant loop 220.

The condensers 226 are heat exchangers that use a suitable cooling medium (e.g., condensing fluid) to draw heat from the steam (secondary coolant) and to condense the steam. In this embodiment, each condenser 226 is fluidly connected to the outside of the hull 110 of the ship 100 to draw water surrounding the hull 110 into the condenser 226 as the condensing fluid. The condensers 226 may be fluidly connected to the water surrounding the hull by a suitable fluid connection, such as condensing fluid lines 232, and a condensing fluid pump 234 may be located within at least one of the condensing fluid lines 232 to circulate the condensing fluid between the condensers 226 and the exterior of the hull 110.

In some embodiments, the condenser 226 may include (or may be) a ballast tank (a cooling ballast tank 229) fluidly connected to the water surrounding the hull 110. A coolant line of the secondary coolant loop 220 may pass through the cooling ballast tank 229 containing water to exchange heat with the water within the ballast tank and cool and/or condense the secondary coolant. Although the cooling ballast tank 229 used to cool a coolant of the nuclear reactor 210 may be the ballast tanks 152 discussed further below, the ballast tanks 152 used for ship stability while underway may be preferably empty during operation of the nuclear reactor 210 to reduce the draft of the ship 100 while moored and connected to the onshore electrical distribution system 310, and thus the cooling ballast tank 229 is a separate ballast tank that has water contained therein while the nuclear reactor 210 is operating. In some embodiments, the cooling ballast tank 229 may also be positioned within the ship 100 to provide shielding of radiation from the nuclear reactor 210.

In some embodiments, an intermediate loop that includes an intermediate heat exchanger may be used. Such an intermediate loop is fluidly connected to the condensers 226 to receive heat from the secondary coolant and then transfer the heat using the intermediate heat exchanger to water from the body of water surrounding the hull 110. Such an intermediate loop may be used, for example, when the ship 100 operates in saltwater or other bodies of water with a constituent that poses a corrosion concern to the condenser 226 (or chiller).

The electricity generation system 200 of this embodiment is located forward of the superstructure 120 in the center half of the ship 100. Components of the electricity generation system 200 and, more specifically, the components of the nuclear reactor 210 and the primary coolant loop 215 may be located within a containment structure 202. In some embodiments, the nuclear reactor 210 is positioned within the hull 110, although portions of the electricity generation system 200 may extend above the main deck 112 and the containment structure 202 may extend above the main deck 112 but is preferably low enough to avoid obstructing the view from the pilothouse 122. The components of the electricity generation system 200 and, more specifically, the components of the nuclear reactor 210 may be located within the ship 100 to minimize trim in an unballasted condition. For example, supporting equipment for the nuclear reactor 210 may be placed aft of the nuclear reactor 210 to help spread the load of the electricity generation system 200 about the longitudinal center of buoyancy (LCB) of the ship 100 (hull 110). In other embodiments, where the reactor vessel 213 is relatively heavy the reactor vessel 213 may be placed with the longitudinal centerline 106 extending therethrough and/or placed at the LCB of the ship 100 (hull 110).

The nuclear reactor 210 produces radiation, and thus shielding 240 is provided to absorb the various forms of radiation produced by the nuclear reactor 210. With the shallow draft of the ship 100, the nuclear reactor 210 and, more specifically, a substantial portion of the reactor vessel 213 (e.g., at least a majority of the reactor vessel 213) may be positioned above the waterline 108 of the ship 100. Accordingly, only the underside of the nuclear reactor 210 can be shielded by the body of water surrounding the hull 110, and the shielding 240 added to the ship 100 may be used to shield other portions of the nuclear reactor 210. The shielding 240 may be positioned around the reactor vessel 213 and/or the primary coolant loop 215. More specifically, the shielding 240 may be positioned laterally around the reactor vessel 213 and/or the primary coolant loop 215, such as outboard and fore and aft of the reactor vessel 213 and/or the primary coolant loop 215. The shielding 240 also may be positioned above the reactor vessel 213 and/or the primary coolant loop 215.

In some embodiments the shielding 240 is fixed shielding 242. The fixed shielding 242 may be, for example, suitable materials for the radiation being shielded such as metal and plastic. When metal is used, the metal may be suitable shielding metals, such as steel or high-density metals, for example, lead or tungsten. The fixed shielding 242 may be, for example, metal plate and/or plastic sheeting positioned around the reactor vessel 213 and/or the primary coolant loop 215.

The nuclear reactor 210 produces the most amount of radiation during operation and thus the shielding 240 is primarily used while the nuclear reactor 210 is operating and shortly thereafter. The nuclear reactor 210 can thus use less shielding 240 when the nuclear reactor 210 is not operating. Instead of or in addition to fixed shielding 242, the shielding 240 may also be removeable (or moveable) shielding. Such removeable shielding may be water, for example. Accordingly, one or more shielding tanks 244 may be positioned around the reactor vessel 213 and/or the primary coolant loop 215 in the manner discussed above. Each shielding tank 244 may be fluidly connected to the water surrounding the hull by a suitable fluid connection, such as a shielding line 246, and a shielding pump 248 may be located in the shielding line 246 to pump water into and/or out of the shielding tanks 244. The water added to the shielding tanks 244 can thus be used to shield radiation from the nuclear reactor 210 when the nuclear reactor 210 is operating. When the nuclear reactor 210 is not operating and the shielding provided by the water in the shielding tanks 244 is not needed, the water can be removed from (e.g., pumped out of) the shielding tanks 244.

As discussed further below, the nuclear reactor 210 is not used to power the ship 100 in some embodiments, and rather used with the ship 100 moored or only during a limited time when the ship 100 is underway. When the ship 100 is underway, the water can be removed from the shielding tanks 244 which lowers the center of gravity of the ship promoting stability of the ship 100 when underway, particularly, in open water conditions. Such lowering of the center of gravity is particularly useful with a substantial portion (e.g., a majority) of the shielding 240 is positioned above the waterline 108. In the embodiment schematically shown in FIG. 2, the shielding 240 used is a combination of fixed shielding 242 and shielding tanks 244.

In the schematic of the electricity generation system 200 shown in FIG. 2, one steam generator 217 and one secondary coolant loop 220 is shown. But the electricity generation system 200 is not so limited, and the reactor vessel 213 may be fluidly coupled to a plurality of steam generators 217 and the electricity generation system 200 may thus have a plurality of secondary coolant loops 220. The electricity generation system 200 may thus also have a plurality of electrical generators 224. As noted above, the nuclear reactor 210 is preferably a microreactor, and, in such embodiments, the electricity generation system 200 and, more specifically, the electrical generators 224 are configured to preferably have a capacity (an electrical output) of 50 megawatts electric (MWe) or less and more preferably between 5 MWe and 50 MWe.

The ship 100 also includes a propulsion system 130 to move the ship 100 through the water. The propulsion system 130 includes an engine 131 and a propulsor 133. The engine 131 is a machine that converts power into motion to drive the propulsor 133 and, more specifically is a machine that produces torque when in operation. The engine 131 may be a gas turbine engine, an internal combustion engine, or an electrical motor, for example. The engine 131 is coupled to a power source 135 suitable for the engine 131. Suitable power sources 135 include, for example, a liquid fuel, such as diesel fuel (petroleum based, biomass based, or a combination thereof) or other hydrocarbon fuel, when the engine 131 is a gas turbine engine or internal combustion engine, or electricity from a battery or fuel cell when the engine 131 is an electrical motor.

The engine 131 is drivingly coupled to the propulsor 133 to transmit torque from the engine 131 to the propulsor 133. The propulsor 133 receives the torque produced by the engine 131 to move the hull 110 through a body of water surrounding the hull 110 as the engine 131 operates. In this embodiment, the propulsor 133 is a propeller and the engine 131 is drivingly coupled to the propulsor 133 by a shaft 137 connected to the propeller (propulsor 133). Accordingly, the ship 100 includes a rudder 114 positioned aft of the propeller (propulsor 133) to steer the ship 100 as the propulsion system 130 moves the ship 100 through the water. Any suitable propulsor 133 and propulsion system 130 may be used, however, including, for example, azimuth thruster/drives (e.g., pod drive) propulsion systems. In addition, although shown with one engine 131 driving a single propeller (propulsor 133), in other embodiments the engine 131 may drive a plurality of propellers (propulsors 133). In still other embodiments, the propulsion system 130 may include a plurality of engines 131 with corresponding propulsors 133.

The engine 131 of this embodiment drives the propulsor 133 separately from the electricity generation system 200 and, more specifically, the nuclear reactor 210. The propulsor 133 receives torque from the engine 131 to move the hull 110 through the body of water surrounding the hull 110 without receiving torque or other input from the electricity generation system 200 and, more specifically, the nuclear reactor 210. The propulsor 133 may thus solely receive torque from the engine 131 to move the hull 110 through the body of water surrounding the hull 110. Put another way, the nuclear reactor 210 is not used to drive the ship 100 through the water or otherwise operate the ship 100 while the ship is underway. The nuclear reactor 210 of this embodiment is not coupled to the propulsor 133 to produce torque for the propulsor 133. More specifically, the nuclear reactor 210 is not fluidly coupled to a machine (such as a turbine) that produces torque to drive the propulsor 133. Such fluid coupling includes indirect fluid coupling where the primary fluid flowing though the nuclear reactor 210 is coupled by a heat exchanger, such as the steam generator 217, to another fluid flowing through another loop, such as secondary coolant loop 220. Rather, the nuclear reactor 210 is used as part of the electricity generation system 200 to provide power to shore as a source of temporary (or emergency) power to an onshore electrical distribution system 310 (see FIG. 3), as will be discussed further below. The propulsion system 130 may thus also include an electrical generator 139 coupled to the engine 131. The engine 131 is drivingly coupled to the electrical generator 139 to provide electricity to the ship 100 while the ship 100 is underway and to operate auxiliary systems of the ship 100.

Preferably, the nuclear reactor 210 is designed with passive safety features such that the nuclear reactor 210 is not dependent on active safety systems in the event of a casualty. The HTGR design discussed herein, for example, enables this passively safe reactor. The propulsion system 130, however, may be used as an emergency back-up system for the nuclear reactor 210 if desired. The propulsion system 130 may thus be connected to the nuclear reactor 210 to provide power to various safety systems of the nuclear reactor 210, such as providing power to operate the suitable gas circulator 219, the secondary coolant pump 228, and/or the condensing fluid pump 234 to cool the core 211 in the event of a casualty.

As discussed further below, the electricity generation system 200 and the nuclear reactor 210 may be operated without adding or constructing additional infrastructure onshore. Accordingly, other emergency or casualty response systems may be located onboard the ship 100 and/or other shipboard systems may be used for both ship operations and the electricity generation system 200 including the nuclear reactor 210. One such system may be a shipboard fire protection system 140. In this embodiment, the fire protection system 140 is a deluge system, but other suitable fire suppression systems may be used. The fire protection system 140 includes one or more sprinkler heads 142 fluidly connected to an extinguishant source 144 to receive an extinguishant from the extinguishant source 144. The extinguishant source 144 may be the body of water surrounding the hull 110 when the extinguishant used is water, but in other embodiments the extinguishant source 144 is a tank (extinguishant tank) containing the extinguishant, such as a chemical extinguishant like halon. The sprinkler heads 142 may be positioned throughout the ship 100, such as within the engine compartments, and also positioned within the containment structure 202 to extinguish fires that may occur within the containment structure 202. The fire protection system 140 also includes one or more deluge valves 146 fluidly connected to the extinguishant source 144 between the extinguishant source 144 and the sprinkler heads 142. When a fire or other hazard is detected, the deluge valves 146 receives a fire hazard signal such as from a detector or a pull station, indicating that a fire hazard has been detected, and an opens in response to the signal to allow the extinguishant to flow from the extinguishant source 144 to the sprinkler heads 142.

As noted above, the ship 100 is preferably designed to minimize weight and to enable a shallow draft when located close to shore 302 (see FIG. 3). However, such a shallow draft may result in the ship 100 having less than ideal sea-keeping characteristics when underway, particularly in heavy weather conditions in open water. The ship 100 and, more specifically, the hull 110 of this embodiment may have one or more ballast tanks 152. Each ballast tank 152 may be fluidly connected to the water surrounding the hull by a suitable fluid connection, such as a ballast line 154, and a ballast pump 156 may be located in the ballast line 154 to pump water into and/or out of the ballast tank 152. The water added to the ballast tank 152 is ballast for the ship 100, increasing the weight and thus the draft of the ship 100. The one or more ballast tanks 152 are configured to be filled with water to ballast the hull 110 and, when ballasted, to increase the draft of the displacement hull 110. The preferred mean draft of the hull 110 discussed above is for the ship 100 (hull 110) when unballasted. Ballast can thus be added using the ballast tank 152, increasing the stability and sea-keeping characteristics of the ship 100 while the ship 100 is underway. When fully ballasted, the one or more ballast tanks 152 may increase the draft of the hull 110 such that the ballasted mean draft is from 70% to 80% of the molded depth of the hull 110.

The ship 100 and, more specifically, the electricity generation system 200 discussed herein may be used as a temporary power plant to provide an emergency source or otherwise a temporary source of electricity to shore as part of a temporary power system 300. FIG. 3 shows a temporary power system 300 according to an embodiment. The marine vessel, ship 100, in this embodiment, is moored in a nearshore region close to the shore 302. In many cases, the ship 100 will be anchored proximate to the shore 302 as the locations for which the electricity generation system 200 is providing electricity may not have a permanent mooring for the ship 100, or such a mooring may be damaged because of severe weather, for example. The ship 100 may be anchored by deploying one or more anchors 109 (see FIG. 2). The ship 100, however, may be moored to a dock (whether permanent or temporary) or other suitable mooring instead of being anchored. In some embodiments, the ship is preferably positioned within 500 feet of the shore 302, more preferably within 300 feet of the shore 302, and even more preferably within 200 feet of the shore 302.

Electricity is distributed onshore by an onshore electrical distribution system 310 such as a power grid or a microgrid, and the electricity generation system 200 is connected to the onshore electrical distribution system 310. In this embodiment, the onshore electrical distribution system 310 includes a substation 312 positioned near the shore 302. Electrical powerlines 314 connect the substation 312 to other parts of the onshore electrical distribution system 310 requiring electricity. The substation 312 includes an onshore electrical connection 316, and the electrical powerlines 314 are electrically connected to the onshore electrical connection 316. The electricity generation system 200 and, more specifically, the electrical generator 224 are electrically connected to the onshore electrical connection 316 by at least one electrical cable 252. In this embodiment, the electrical cable 252 is part of the electricity generation system 200 and can be detachably connected to the onshore electrical connection 316 to provide electricity from the electricity generation system 200 to the onshore electrical distribution system 310. With the ship positioned proximate the shore 302, the cable preferably has a length that is 500 feet or less, and more preferably from 200 feet to 300 feet.

The electrical cable 252 of this embodiment extends from the ship 100 to the onshore electrical connection 316 and is supported by a support, such as a plurality of buoys 322. Supporting the electrical cable 252 by the plurality of buoys 322 allows this system to be deployed and quickly adapted to many different maritime environments. With the ship 100 being anchored, the ship 100 may rotate with the wind and currents, and rise and lower with tides. Supporting the electrical cable 252 by the plurality of buoys 322 allows the electrical cable 252 to float and to move along with the ship 100 in these conditions. In addition, supporting the electrical cable 252 by the plurality of buoys 322 allows the electrical cable 252 to be deployed regardless of the specific contours of the seabed, avoiding reefs, and the like. The buoys 322 may be thirty-six inches in diameter or less and spaced as required to support the weight of the electrical cable 252. By positioning the ship 100 close to shore 302, the weight of the electrical cable 252 is minimized and some of the weight of the electrical cable 252 is supported by the ship 100. With the electrical cable 252 supported by the plurality of buoys 322, the electrical cable 252 is positioned on the surface of the water and/or above the surface of the water.

In some embodiments, the buoys 322 may be stored on the ship 100, and the ship 100 may also include at least one small boat 324 (see FIG. 1) that can be operated as a buoy tender to deploy the buoys 322 and the electrical cable 252. The ship 100 may also be equipped with a hoist 326 (see FIG. 1) to deploy and to recover the small boat 324. The small boat 324 is a boat that is capable of being stored onboard the ship 100. As noted above, such boats may also be capable of being deployed (recovered) by the use of a hoist 326. The small boat 324 may be, for example, a rigid inflatable boat or a boat with a solid hull and an inflatable collar (either air filled or foam filled). The small boat may include works boats that are preferably fifty feet in length or less and, more preferably, forty feet in length or less. Such boats may be semi-displacement hull boats and include aluminum hulled landing craft, with a relatively flat hull bottom to minimize draft and aid in beaching the craft. Also, to minimize draft, the small boat 324 may be a water jet powered boat and thus include a marine propulsion system that is a water jet drive. With such features to minimize the draft, the small boat 324 can get close to shore 302 to place the buoys 322 and deploy the electrical cable 252.

The electrical cable 252 of this embodiment is deployable and is thus movably connected to the hull 110 to move between a stowed position and a deployed position. The electrical cable 252 is shown in the deployed position in FIG. 3 where it is suspended from the plurality of buoys 322 and connected to the onshore electrical connection 316. FIG. 2 shows the electrical cable 252 in its stowed position. In its stowed position, the electrical cable 252 is stowed aboard the ship 100. Various suitable methods may be used to stow the electrical cable 252 onboard the ship 100. In this embodiment, the ship 100 includes a cable reel 254, and the electrical cable 252 is configured to be wound on the cable reel 254 and unwound from the cable reel 254 to move between the stowed position and the deployed position, respectively. A drive mechanism 256 is drivingly connected to the cable reel 254 to rotate the cable reel 254 and, to deploy or to retract the electrical cable 252. Any suitable drive mechanism 256 may be used, including, for example, an electrical motor or a hydraulic motor. In this embodiment, the drive mechanism 256 is an auxiliary system of the ship 100 powered by the propulsion system 130. To protect the electrical cable 252 from the elements, particularly, in the marine environment, the electrical cable 252 and the cable reel 254 are protected by an enclosure 258 in the stowed position. Although the enclosure 258 is shown in FIG. 2 as a structure located on the main deck 112, the enclosure 258 can be located other parts of the ship 100, such as the hull 110, for example.

As will be discussed further below, the shipborne microreactor discussed herein can begin to provide electrical power quickly as the ship 100 include features and components that enable the electricity generation system 200 and nuclear reactor 210 to be operated without adding or constructing additional infrastructure onshore. The electricity generation system 200 may thus further include a transformer 262 positioned onboard the ship 100 (within the hull 110), as shown in FIG. 2. The transformer 262 is electrically connected to the electrical generator 224 to transform the voltage of the electricity produced by the electrical generator 224 to voltages suitable for distribution in the onshore electrical distribution system 310. In some embodiments, the onboard transformer 262 allows the electricity generation system 200 to be electrically connected to the onshore electrical distribution system 310 at points other than the substation 312. The transformer 262 may be electrically positioned between the electrical generator 224 and the electrical cable 252 and/or the cable reel 254.

The electricity generation system 200 including the nuclear reactor 210 may be operated from a control room 124 (also referred to as an electricity generation system control room and a reactor control room). The control room 124 may be located at various locations onboard the ship 100, but in the embodiment shown in FIG. 2, the control room 124 is located within the superstructure 120. For security reasons, the control room 124 is preferably a room that can be secured apart from other compartments within the ship 100. More specifically, the control room 124 is located apart from the pilothouse 122. With the control room 124 located onboard the ship 100, the electricity generation system 200 and the nuclear reactor 210 can be operated without adding or constructing additional infrastructure onshore, as discussed further below.

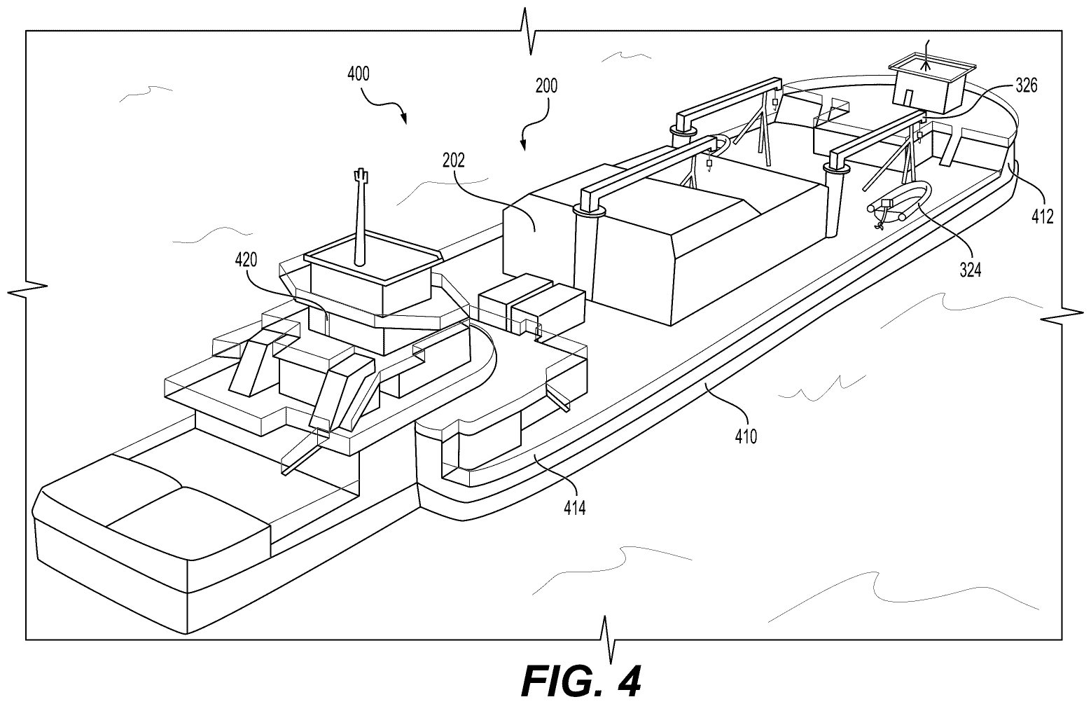

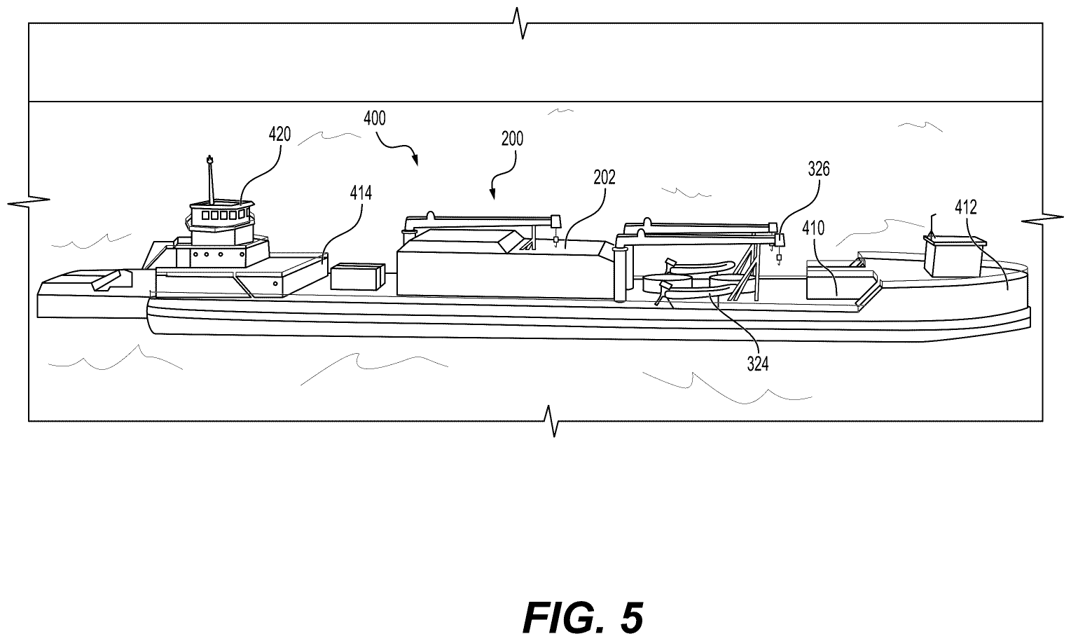

FIGS. 4 and 5 show another marine vessel equipped with the electricity generation system 200 and the nuclear reactor 210 in accordance with another preferred embodiment. The marine vessel described in the embodiment above is a ship 100, more specifically, a tanker-style ship. The marine vessel is not so limited, however, and other marine vessels may be equipped with the electricity generation system 200 and operated as described herein. Other suitable marine vessels include barges that can be moved by tugs. The marine vessels discussed herein are preferably suitable for safe ocean passage, and, when the marine vessel is a barge, the marine vessel is preferably an integrated tug barge (ITB) or an articulated tug barge (ATB).

FIGS. 4 and 5 show an articulated tug barge 400 equipped with the electricity generation system 200 and the nuclear reactor 210. The articulated tug barge 400 of this embodiment is similar to the electricity generation system 200 discussed above with reference to FIGS. 1 to 3. The description of these components above also applies to this embodiment, and a detailed description of these components is omitted here. Thus, the same reference numerals will be used for components of the articulated tug barge 400 of this embodiment that are the same as or similar to the components of the ship 100 discussed above.

The articulated tug barge 400 includes a barge 410 and a tugboat 420. The barge 410 includes a bow 412 and a stern 414. As noted above, the articulated tug barge 400 is preferably designed for safe ocean operation, and thus the bow 412 is preferably a ship-shaped bow, having a V shape, for example. The stern 414 of the barge 410 includes a U-shaped recess that is shaped and sized for the corresponding tugboat 420 to be located therein. Portions of the barge 410 may thus extend alongside the tugboat 420.

The tugboat 420 is connected to the barge 410 within the U-shaped recess by a suitable coupler system. In this embodiment, the barge and the tug unit is an articulated tug barge, and thus the coupler system allows for fore and aft pitch movement between the barge 410 and the tugboat 420. Any suitable articulated or “hinged” connection system may be used, including, for example, the Intercon Coupler System™, produced by Intercontinental Engineering-Manufacturing Corporation of Kansas City, Missouri.

Microreactors, such as those discussed herein, can be made small enough that their components can be transported by container via truck, plane, or ship, and then assembled to provide a temporary source of electricity. Because such an approach requires set-up followed by start-up of the reactor, such an approach is time-consuming. The shipborne microreactor discussed herein can provide emergency or temporary electrical power more quickly. The electricity generation system 200 is already assembled on the marine vessel (e.g., the ship 100 or the articulated tug barge 400), avoiding the assembly time. In addition, start-up of nuclear reactors can be a time-consuming process. The nuclear reactor 210 discussed herein can be started up while the marine vessel (e.g., the ship 100 or the articulated tug barge 400) is underway, such as while the marine vessel (e.g., the ship 100 or the articulated tug barge 400) is still transiting to the location where the electricity will be supplied. When underway the marine vessel (e.g., the ship 100 or the articulated tug barge 400) is not at anchor, made fast to the shore, or aground. In such a case, the electricity generation system 200 of the marine vessel (e.g., the ship 100 or the articulated tug barge 400) can begin providing electricity to the onshore electrical distribution system 310 as soon as the marine vessel arrives and is connected to the onshore electrical distribution system 310. The following discussion will refer to the marine vessel, which as noted in this paragraph, may be the ship 100 or the articulated tug barge 400 discussed herein.

To enable such operations, the shipborne microreactor discussed herein includes features and components that enable the electricity generation system 200 and nuclear reactor 210 to be operated without adding or constructing additional infrastructure onshore. These components and systems are located onboard the marine vessel so that they can be used while the marine vessel is underway. For example, the nuclear reactor 210 may have a black start capability that does not rely upon infrastructure external to the ship 100 to start-up and does not need to be connected to an external power grid for start-up. Instead, the nuclear reactor 210 may be electrically connected to a start-up electrical power source onboard the ship 100 for start-up operations. Suitable start-up electrical power sources include, for example, the propulsion system 130 and, more specifically, the electrical generator 139 to provide power for start-up. Other suitable start-up electrical power sources include on board battery storage. The start-up electrical power source, such as the electrical generator 139 of the propulsion system 130, provides power for the control rod drive mechanism 212 and other instrumentation and controls needed to start-up the reactor.

As noted above, an advantage of the shipborne microreactor discussed herein is the ability to start-up the reactor while underway. A method of operating the marine vessel thus includes operating the marine vessel underway and starting up the nuclear reactor 210, while the marine vessel is underway. Starting up the nuclear reactor 210 includes providing power from an electrical power source, such as the electric generator 139, as discussed above, to the control rod drive mechanism 212 to withdraw control rods within the nuclear reactor. The nuclear reactor 210 is preferably started up and maintained in a standby condition. In the standby condition, the nuclear reactor 210 may be maintained at a power level below the point at which active heat removal is required.

The marine vessel can transit to the location where the electricity generation system 200 will be used to provide electricity. The nuclear reactor 210 may be started up with the marine vessel making way and moving through the water, as discussed above, but the nuclear reactor 210 may also be started up when the marine vessel is in other underway operating conditions, and then transited to the location where the electricity generation system 200 will be used to provide electricity. With the nuclear reactor 210 being started up before or during transit, electricity generation is not needed and the nuclear reactor 210 is thus preferably maintained in standby while transiting. Once the marine vessel arrives at the location where the electricity generation system 200 will be used to provide electricity, the marine vessel is moored, as discussed above, and then the electrical generator 224 is connected to the onshore electrical distribution system 310 in the manner discussed above. With the electrical generator 224 connected to the onshore electrical distribution system 310, the nuclear reactor 210 can quickly be brought up from standby to an at-power operation, and the turbines 222 and electrical generator 224 brought online to provide electricity to the onshore electrical distribution system 310.

Further aspects of the present disclosure are provided by the subject matter of the following clauses.

A marine vessel comprising a hull, a propulsion system, and an electricity generation system. The propulsion system includes an engine and a propulsor. The engine produces torque when in operation and is drivingly coupled to the propulsor to transmit torque from the engine to the propulsor. The propulsor receives torque from the engine to move the hull through a body of water surrounding the hull. The electricity generation system includes a nuclear reactor and an electrical generator. The nuclear reactor is coupled to the electrical generator to generate electricity to be capable of providing electricity to shore when the nuclear reactor is operating at power.

The marine vessel of the preceding clause, wherein the engine is one of a gas turbine engine, an internal combustion engine, and an electrical motor.

The marine vessel of any preceding clause, wherein the propulsor is a propeller and the engine is drivingly coupled to the propulsor by a shaft connected to the propeller.

The marine vessel of any preceding clause, the propulsion system moves the hull through the body of water surrounding the hull free from input from the electricity generation system.

The marine vessel of any preceding clause, wherein the propulsor solely receives torque from the engine to move the hull through the body of water surrounding the hull.

The marine vessel of any preceding clause, wherein the electricity generation system includes shielding positioned at least partially around the nuclear reactor, the shielding including at least one shielding tank capable of being filled with water to shield from radiation emitted from the nuclear reactor.

The marine vessel of any preceding clause, wherein the hull has a waterline and the nuclear reactor includes a reactor vessel, a majority of the reactor vessel being located above the waterline when the hull is in an unballasted condition.

The marine vessel of any preceding clause, further comprising a transformer electrically connected to the electrical generator to transform the voltage of the electricity produced by the electrical generator.

The marine vessel of any preceding clause, wherein the electricity generation system further includes least one turbine drivingly connected to an electrical generator such that, as the least one turbine rotates, the electrical generator generates electricity, the least one turbine being fluidly connected to a steam source to receive steam from the steam source and to rotate the least one turbine, the steam source receiving heat from the nuclear reactor and generating steam when the nuclear reactor is operating at power.

The marine vessel of any preceding clause, further comprising a control room for controlling the electricity generation system.

The marine vessel of any preceding clause, further comprising a pilothouse for operating the marine vessel, the control room being located apart from the pilothouse.

The marine vessel of any preceding clause, wherein the hull is a displacement hull.

The marine vessel of any preceding clause, wherein the displacement hull has a beam width of at least 85 feet.

The marine vessel of any preceding clause, wherein the displacement hull has a draft of 12 feet or less.

The marine vessel of any preceding clause, further comprising one or more ballast tanks configured to be filled with water to ballast the displacement hull.

The marine vessel of any preceding clause, wherein, when the displacement hull is ballasted, the water increases the draft of the displacement hull.

The marine vessel of any preceding clause, wherein the displacement hull has a draft of 12 feet or less when unballasted.

The marine vessel of any preceding clause, further comprising an electrical cable electrically connected to the electrical generator and capable of connecting the electrical generator to an onshore electrical distribution system.

The marine vessel of any preceding clause, further comprising a transformer electrically connected to the electrical generator to transform the voltage of the electricity produced by the electrical generator, the transformer being electrically positioned between the electrical generator and the electrical cable.

The marine vessel of any preceding clause, wherein the electrical cable is movably connected to the hull to move between a stowed position and a deployed position.

The marine vessel of any preceding clause, further comprising a cable reel, the electrical cable configured to be wound on the cable reel and unwound from the cable reel to move between the stowed position and the deployed position, respectively.

A temporary power system including a marine vessel and an onshore electrical distribution system having an onshore electrical connection. The marine vessel includes a hull and an electricity generation system. The electricity generation system includes an electrical generator and a nuclear reactor. The electrical generator is coupled to the nuclear reactor to generate electricity when the nuclear reactor is operating. An electrical cable electrically connects the electrical generator and the onshore electrical connection to provide electricity from the electricity generation system to the onshore electrical distribution system. The temporary power system also includes a support for supporting the electrical cable between the marine vessel and the onshore electrical connection.

The temporary power system of the preceding clause, wherein the electricity generation system has a capacity of 50 megawatts electric or less.

The temporary power system of any preceding clause, wherein the electricity generation system has a capacity between 5 megawatts electric and 50 megawatts electric.

The temporary power system of any preceding clause, wherein the marine vessel further includes a transformer electrically connected to the electrical generator to transform the voltage of the electricity produced by the electrical generator, the transformer being electrically positioned between the electrical generator and the electrical cable.

The temporary power system of any preceding clause, wherein the electrical cable is detachably connected to the onshore electrical connection.

The temporary power system of any preceding clause, wherein the electrical cable is movably connected to the marine vessel to move between a stowed position and a deployed position, the plurality of buoys supporting the electrical cable when the electrical cable is in the deployed position.

The temporary power system of any preceding clause, further comprising a cable reel, the electrical cable being wound on the cable reel in the stowed position.

The temporary power system of any preceding clause, wherein the support positions the electrical cable at least one of (i) on a surface of a body of water surrounding the hull and (ii) above the surface of the body of water surrounding the hull.

The temporary power system of any preceding clause, wherein the support is a plurality of buoys.

The temporary power system of any preceding clause, wherein the marine vessel is a barge.

The temporary power system of any preceding clause, wherein the barge has a draft of 12 feet or less.

The temporary power system of any preceding clause, wherein the marine vessel is a ship having a displacement hull.

The temporary power system of any preceding clause, wherein the ship has a draft of 12 feet or less.

The temporary power system of any preceding clause, wherein the marine vessel further includes a control room for controlling the electricity generation system.

The temporary power system of any preceding clause, wherein the marine vessel further includes a pilothouse for operating the marine vessel, the control room being located apart from the pilothouse.

The temporary power system of any preceding clause, wherein the ship includes a propulsion system including an engine and a propulsor, the engine producing torque when in operation and drivingly coupled to the propulsor to transmit torque from the engine to the propulsor, the propulsor receiving torque from the engine to move the displacement hull through a body of water surrounding the displacement hull without receiving torque from the nuclear reactor.

A method of operating a marine vessel, including the marine vessel of any preceding clause. The marine vessel having an electricity generation system including a nuclear reactor and an electrical generator. The method including operating the marine vessel underway, starting up the nuclear reactor, while the marine vessel is underway, and maintaining the nuclear reactor in a standby condition, while the marine vessel is underway.

The method of any preceding clause, wherein starting up the nuclear reactor includes providing power from an electrical power source to a control rod drive mechanism to withdraw control rods within the nuclear reactor.

The method of any preceding clause, wherein the marine vessel includes a propulsion system including an engine and an electrical generator coupled to the engine, the engine being drivingly coupled to the electrical generator to provide electricity as the electrical power source.

The method of any preceding clause, further including moving the marine vessel through a body of water surrounding a hull using a propulsion system. The propulsion system includes an engine and a propulsor coupled to the engine to receive torque produced by the engine.

The method of any preceding clause, wherein moving the marine vessel includes moving the marine vessel through the body of water using the propulsion system while starting up the nuclear reactor.

The method of any preceding clause, wherein moving marine vessel includes moving the marine vessel through the body of water using the propulsion system while maintaining the nuclear reactor in a standby condition.

The method of any preceding clause, further including mooring the marine vessel and electrically connecting an electrical generator of an electricity generation system located onboard the marine vessel to an onshore electrical distribution system. The electricity generation system includes the electrical generator and the nuclear reactor. The electrical generator coupled to the nuclear reactor to generate electricity when the nuclear reactor is operating at power.

The method of any preceding clause, wherein mooring the marine vessel includes anchoring the marine vessel.

The method of any preceding clause, further including operating the electricity generation system with the nuclear reactor at power to generate electricity and provide the electricity to the onshore electrical distribution system.

The method of any preceding clause, wherein electrically connecting an electrical generator of an electricity generation system located onboard the marine vessel to an onshore electrical distribution system includes deploying an electrical cable movably connected to a hull of the marine vessel.

The method of any preceding clause, wherein deploying the electrical cable includes unwinding the electrical cable from a cable reel.

The method of any preceding clause, wherein deploying the electrical cable includes deploying a plurality of buoys to support the electrical cable between the marine vessel and an onshore electrical connection of the onshore electrical distribution system.

Although this invention has been described with respect to certain specific exemplary embodiments, many additional modifications and variations will be apparent to those skilled in the art in light of this disclosure. This invention, therefore, may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

1. A marine vessel comprising:
a hull;
a propulsion system including an engine and a propulsor, the engine producing torque when in operation and drivingly coupled to the propulsor to transmit torque from the engine to the propulsor, the propulsor receiving torque from the engine to move the hull through a body of water surrounding the hull; and
an electricity generation system including a nuclear reactor and an electrical generator, the nuclear reactor coupled to the electrical generator to generate electricity to be capable of providing electricity to shore when the nuclear reactor is operating at power.

2. The marine vessel of claim 1, wherein the engine is one of a gas turbine engine, an internal combustion engine, and an electrical motor.

3. The marine vessel of claim 1, wherein the propulsor is a propeller and the engine is drivingly coupled to the propulsor by a shaft connected to the propeller.

4. The marine vessel of claim 1, wherein the propulsion system moves the hull through the body of water surrounding the hull free from input from the electricity generation system.

5. The marine vessel of claim 1, wherein the propulsor solely receives torque from the engine to move the hull through the body of water surrounding the hull.

6. The marine vessel of claim 1, wherein the electricity generation system includes shielding positioned at least partially around the nuclear reactor, the shielding including at least one shielding tank capable of being filled with water to shield from radiation emitted from the nuclear reactor.

7. The marine vessel of claim 1, wherein the hull has a waterline and the nuclear reactor includes a reactor vessel, a majority of the reactor vessel being located above the waterline when the hull is in an unballasted condition.

8. The marine vessel of claim 1, further comprising a transformer electrically connected to the electrical generator to transform the voltage of the electricity produced by the electrical generator.

9. The marine vessel of claim 1, wherein the electricity generation system further includes least one turbine drivingly connected to an electrical generator such that, as the least one turbine rotates, the electrical generator generates electricity, the least one turbine being fluidly connected to a steam source to receive steam from the steam source and to rotate the least one turbine, the steam source receiving heat from the nuclear reactor and generating steam when the nuclear reactor is operating at power.

10. The marine vessel of claim 1, further comprising a control room for controlling the electricity generation system.

11. The marine vessel of claim 10, further comprising a pilothouse for operating the marine vessel, the control room being located apart from the pilothouse.

12. The marine vessel of claim 1, wherein the hull is a displacement hull.

13. The marine vessel of claim 12, wherein the displacement hull has a beam width of at least 85 feet.

14. The marine vessel of claim 13, wherein the displacement hull has a draft of 12 feet or less.

15. The marine vessel of claim 12, further comprising one or more ballast tanks configured to be filled with water to ballast the displacement hull.

16. The marine vessel of claim 15, wherein, when the displacement hull is ballasted, the water increases the draft of the displacement hull.

17. The marine vessel of claim 15, wherein the displacement hull has a draft of 12 feet or less when unballasted.

18. The marine vessel of claim 1, further comprising an electrical cable electrically connected to the electrical generator and capable of connecting the electrical generator to an onshore electrical distribution system.

19. The marine vessel of claim 18, further comprising a transformer electrically connected to the electrical generator to transform the voltage of the electricity produced by the electrical generator, the transformer being electrically positioned between the electrical generator and the electrical cable.

20. The marine vessel of claim 18, wherein the electrical cable is movably connected to the hull to move between a stowed position and a deployed position.

21. The marine vessel of claim 20, further comprising a cable reel, the electrical cable configured to be wound on the cable reel and unwound from the cable reel to move between the stowed position and the deployed position, respectively.

22. A temporary power system comprising:
an onshore electrical distribution system including an onshore electrical connection;
a marine vessel including a hull and an electricity generation system, the electricity generation system including a nuclear reactor and an electrical generator, the nuclear reactor coupled to the electrical generator to generate electricity when the nuclear reactor is operating;
an electrical cable electrically connecting the electrical generator and the onshore electrical connection to provide electricity from the electricity generation system to the onshore electrical distribution system; and
a support for supporting the electrical cable between the marine vessel and the onshore electrical connection.

23.-37. (canceled)

38. A method of operating a marine vessel having an electricity generation system including a nuclear reactor and an electrical generator, the method comprising:
operating the marine vessel underway;
starting up the nuclear reactor, while the marine vessel is underway; and
maintaining the nuclear reactor in a standby condition, while the marine vessel is underway.

39.-49. (canceled)
